(19) United States
(12) Patent Application Publication
(10) Pub. No.: US 2018/0082523 A1
(43) Pub. Date: Mar. 22, 2018

(54) GAMING MACHINE WITH IMPROVED CABINET

(71) Applicant: Everi Games, Inc., Austin, TX (US)

(72) Inventors: James Palermo, Austin, TX (US); Travis Bussey, Austin, TX (US); Daniel Gibson, Austin, TX (US); Craig Gallagher, Austin, TX (US)

(73) Assignee: Everi Games, Inc., Austin, TX (US)

(21) Appl. No.: 15/716,017

(22) Filed: Sep. 26, 2017

Related U.S. Application Data
(63) Continuation-in-part of application No. 29/618,475, filed on Sep. 21, 2017.
Application No. 29/618,475 is a continuation-in-part of application No. 29/578,622, filed on Sep. 22, 2016.

(51) Int. Cl. G07F 17/32

(52) U.S. Cl. CPC G07F 17/3216; G07F 17/3244; G07F 17/3211

(57) ABSTRACT

An improved gaming machine cabinet is provided for optimizing gaming machine placement in groups. Tapering wall sections of the cabinet allow for closer placement of machines in various group configurations than is possible with similarly sized rectangular cabinets. Group configurations are provided for back-to-back rows and for circular groups of machines.

### CROSS REFERENCE TO RELATED APPLICATIONS

This application is a continuation-in-part of U.S. patent application Ser. No. 29/618,475, filed Sep. 21, 2017 and titled “Hexagonal Bank of Gaming Machines With Topper Display.” This application is also a continuation-in-part of U.S. patent application Ser. No. 29/578,622 filed Sep. 22, 2016 and titled “Gaming Machine.” The entire contents of these two parent applications are hereby incorporated by reference for all purposes.

### FIELD OF THE INVENTION

This invention relates to gaming systems and to gaming machines through which players may participate in wagering games, and in particular slot machine games with a feature game that provides accumulating persistent events.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. Such gaming machines are typically deployed on a casino floor or other gaming area in which optimal use of space is important for gamer comfort and casino revenues. It is noted that traditional upright gaming machines are housed in cabinets that are approximately 19 to 21⅜ inches wide. Pedestal-mounted versions of traditional upright gaming machines are typically operated on pedestals approximately 28 inches wide. The machines are often deployed in rows of back-to-back machines, or in circular groups of three or more machines, often five, with the machine backs facing each other.

What is needed are ways to reduce the use of space on gaming room floors to allow more machines to fit in designate areas.

### SUMMARY OF THE INVENTION

An improved gaming machine cabinet is provided for optimizing gaming machine placement in groups. Tapering wall sections of the cabinet allow for closer placement of machines in various group configurations than is possible with similarly sized rectangular cabinets. Group configurations are provided for back-to-back rows and for circular groups of machines.

According to one embodiment, a gaming machine is provided with a cabinet having tapered wall sections along the right and left cabinet sides, providing for a narrower cabinet back than the cabinet front. The gaming machine is configured to be placed in groups with the tapering wall sections adjacent each other, allowing for closer spacing along certain dimensions than is possible with similarly sized gaming machines. This allows for less use of gaming room floor space.

According to another embodiment, groups of gaming machines are provided configured for placement in a circular configuration with the tapered wall sections of their cabinets adjacent each other. In some implementations, the tapered wall sections are placed in contact with those of adjacent machines in the group. Spacer elements may be used to close gaps between the fronts of machines in the group. A round topper display may be mounted atop the group, spanning above all the machines in the group. In some implementations, the gaming machines have primary and secondary displays, with at least the secondary displays extending sideways past the edge of the cabinet.

According to another embodiment, groups of gaming machines are provided configured for placement in a back-to-back opposing row configuration with the tapered wall sections of their cabinets adjacent each other, with their respective tapering wall sections are adjacent the respective tapering wall section of at least one machine in the opposing row, the tapering wall section constructed to allow a closer spacing of said rows than possible with a similar width rectangular machine.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 is a perspective view from above and to the right of a gaming machine showing the new design.

FIG. 2 is a left side view of the gaming machine shown in FIG. 1.

FIG. 3 is a right side view of the gaming machine shown in FIG. 1.

FIG. 4 is a front view of the gaming machine shown in FIG. 1.

FIG. 5 is a rear view of the gaming machine shown in FIG. 1.

FIG. 6 is a top view of the gaming machine shown in FIG. 1.

FIG. 7 is a bottom view of the gaming machine shown in FIG. 1.

FIG. 8 is a top-down view of an arrangement of gaming machines.

FIGS. 9-16 show a series of top-down diagrams showing group configurations of gaming machines 100 with the cabinet design described above compared to same-sized groups with spacing set at the equivalent of a rectangular machine with other dimensions all similar.

FIG. 17 is a diagram showing a comparison of row configurations for traditional rectangular gaming machine cabinets versus rows of gaming machine cabinets as described herein.

FIG. 18 is a perspective view of a group of six gaming machines including a topper display.

### DETAILED DESCRIPTION OF EXAMPLE EMBODIMENTS

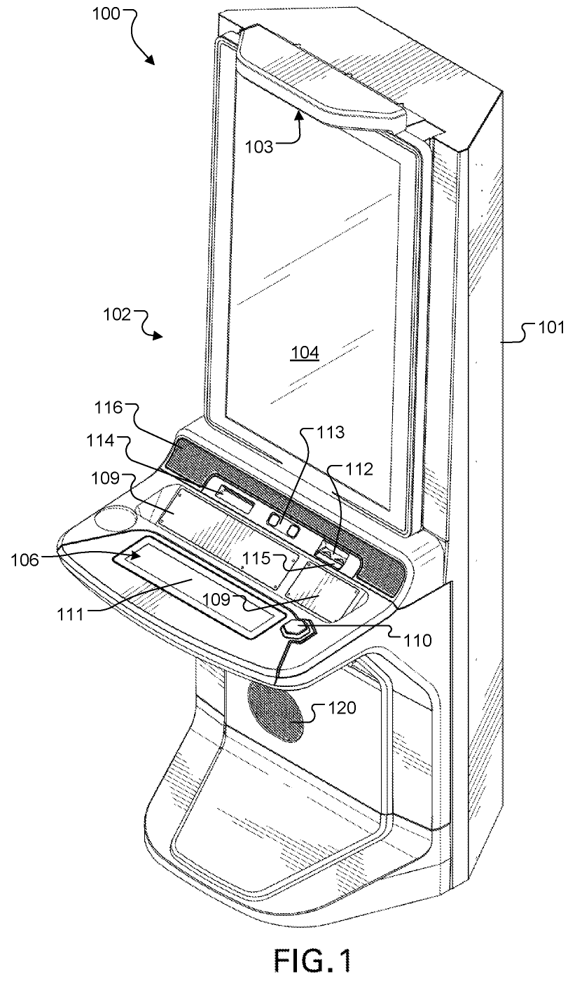

FIG. 1 shows a gaming machine 100 according to an example embodiment the present invention. Gaming machine 100 includes a cabinet 101 having a front side generally shown at reference numeral 102. A primary video display device 104 is mounted in a central portion of the front surface 102, with a player control ledge 106 positioned below the primary video display device and projecting forwardly from the plane of the primary video display device. In addition to primary video display device 104, gaming machine 100 may include a secondary video display device positioned above the primary video display device 104 (with the displays 104 being shorter than depicted in this version). It should also be noted that each display device referenced herein may include any suitable display device including a liquid crystal display, plasma display, LED display, and touchscreen versions of the each, or any other type of display device currently known or that may be developed in the future. The cabinet front is preferably 28 inches wide, however this is not limiting and smaller or larger cabinets may be used. An overhead light 103 projects forward above the display(s) to provide illumination downward over the player controls. The plane of display mounting area on front surface 102 is preferably inclined rearwardly no more than approximately 15° with respect to vertical.

In the preferred version as illustrated, gaming machine 100 also includes one or more mechanical control buttons 110 mounted on ledge 106. The front of ledge 105 includes an armrest 111 and a cup holder toward the left. Also on ledge 106, in this example presented at a forward-facing angle are secondary control touchscreen displays 109, which are programmable to present touchscreen controls. Together the touchscreen controls mechanical button(s) allow a player to select a bet level, select paylines, select a type of game or game feature, and activate a play and wager in a primary game. Further, primary video display device 104 may also be used for presenting touchscreen controls. Gaming machine 100 may also include a number of other player interface devices in addition to devices that are considered player controls for use in playing a particular game. The ledge 106 may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor having an input ramp 112, a player card reader having a player card input 114, and a voucher/receipt printer having a voucher/receipt output 115. A pair of buttons 113 between the player card input 114 and voucher reader 112 provide a Cash Out control and a Service control for calling staff assistance. Audio speakers 116 generate an audio output to enhance the user's playing experience. A subwoofer speaker mounted inside cabinet 101 underneath ledge 106 has a subwoofer grill 120 presented on the front face. Numerous other types of devices may be included in gaming machines that may be used according to the present invention.

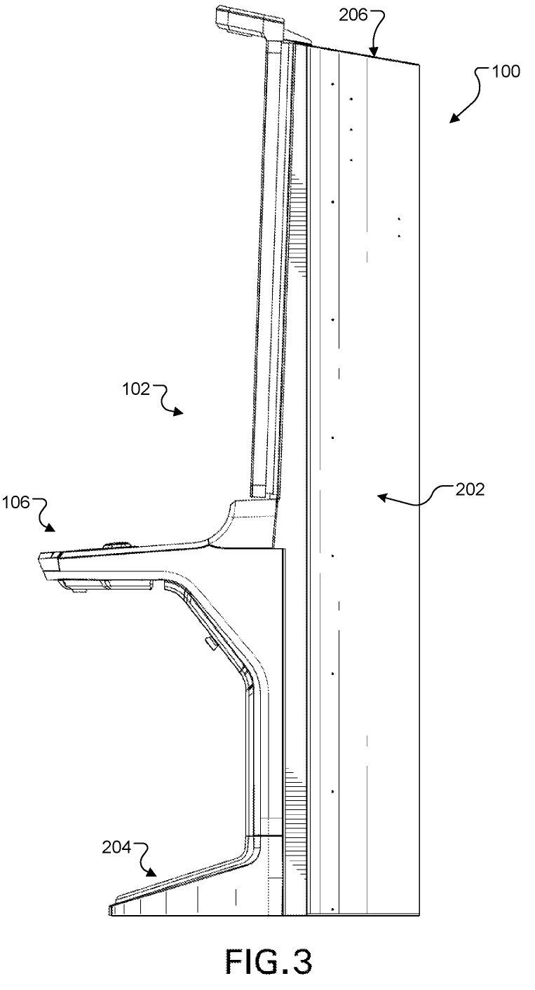

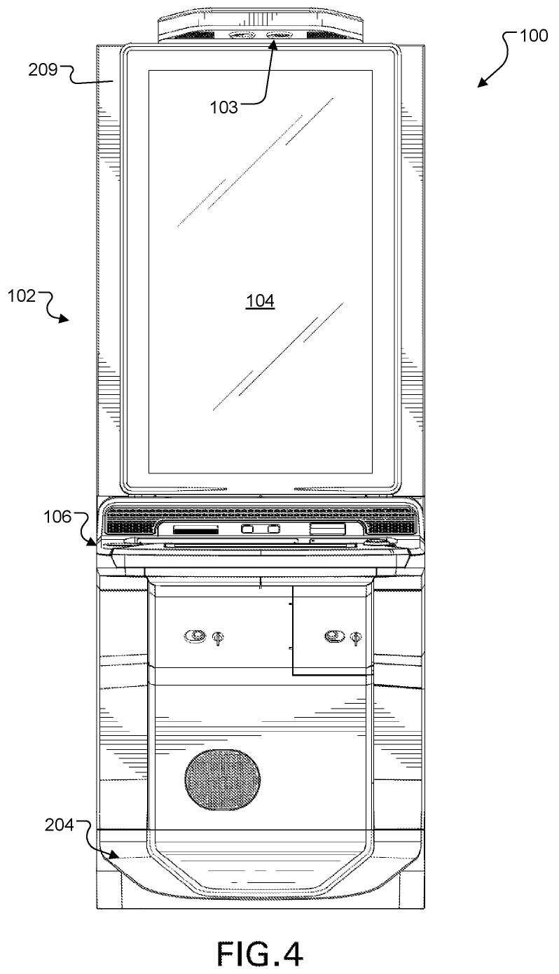

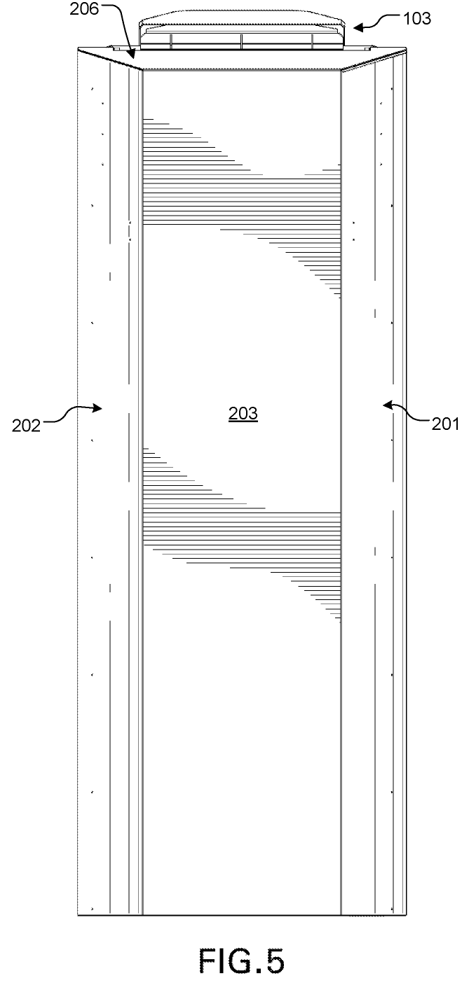

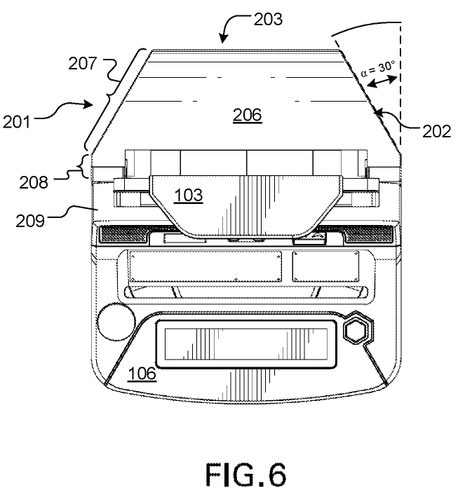

Referring now to FIGS. 1-7, the structure of cabinet 101 will be further described. Cabinet 101 generally includes the cabinet front 102 as described, a cabinet back 203, a left cabinet side 201, a right cabinet side 202, a cabinet bottom 205, and a cabinet top 206, which together define an enclosure volume holding electronic assemblies and structural elements of the gaming machine. As can be seen in the top-down view of FIG. 6, for example, the left and right cabinet sides 201 and 202 are constructed with opposing tapering wall sections 207 toward the cabinet back 203, the tapering wall sections 207 connected to the cabinet back 203, with the cabinet back having a smaller width than that of the cabinet front. The angle formed by the tapering wall sections 207 on the right and left sides of cabinet 101 is preferably 30 degrees from a rectangular configuration, in other words 30 degrees from parallel to the flat, untapered portion 208 of the cabinet sides (or from an angle perpendicular to the front side 102 if no untapered portion of the side walls is used). This provides a narrower cabinet dimension along the cabinet back 203 than the cabinet front 102 throughout the entire span from the cabinet bottom 205 to the cabinet top 206. The tapering wall sections 207 preferably extend around 60-65% of the distance from the cabinet back to the front of display 104 at the bottom of display 104. However, this is not limiting and similar benefits to those described below may be obtained with embodiments in which the tapering wall sections extending less of the distance, for example less than 60%, or more of the distance, for example at least 60%, at least 70%, at or at least 80% of the distance.

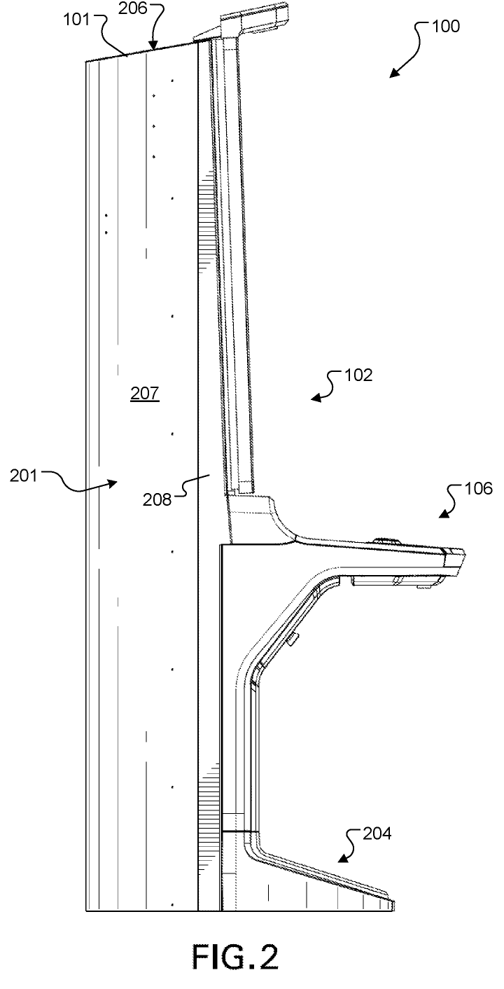

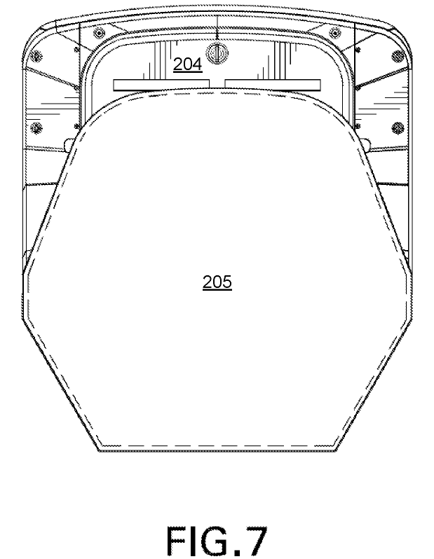

In FIG. 6, it can be seen that the left and right cabinet sides 201 and 202 further include substantially parallel wall sections 208 toward the cabinet front. Other versions may include the entire side walls being tapered, with a rounded corner at the transition to the front side 102. As can be seen in the left side view of FIG. 2, the parallel wall section 208 has a constant width from bottom to approximately the level of player control ledge 106, and then has a tapering width from there to the cabinet top 206, to accommodate a slight backward tilt of the display. A base footrest 204 extends forward from the cabinet front 102 at the bottom. As seen in the bottom view of FIG. 7, the base central portion of cabinet bottom 205 may extend forward underneath the display and partially underneath a portion of the footrest 204 for stability.

In construction, cabinet 101 is preferably manufactured as a modular base assembly or nucleus made up of right and left cabinet sides 201 and 202, cabinet back 203, and a front surface to which are mounted trim pieces, an assembly for the player control ledge 106, and the displays are mounted. The flat, opposing (non-tapered) portion of the cabinet sides 201 and 202 may partially or wholly be constructed of such trim pieces. For example, in the top-down view of FIG. 6, it can be seen than part of the cabinet side portion 208 is integral with the structure of the tapered portion 207, while the forward part of the flat portions 208 are constructed of trim pieces added to a modular base assembly seen by its top 206 in the view. In front of the opposing portions 208 is the display trim piece 209 which forms the front corners and the front portion of the cabinet sides 201 and 202. Overhead light 103 is held in a trim assembly mounted to extend forward from the cabinet top 206.

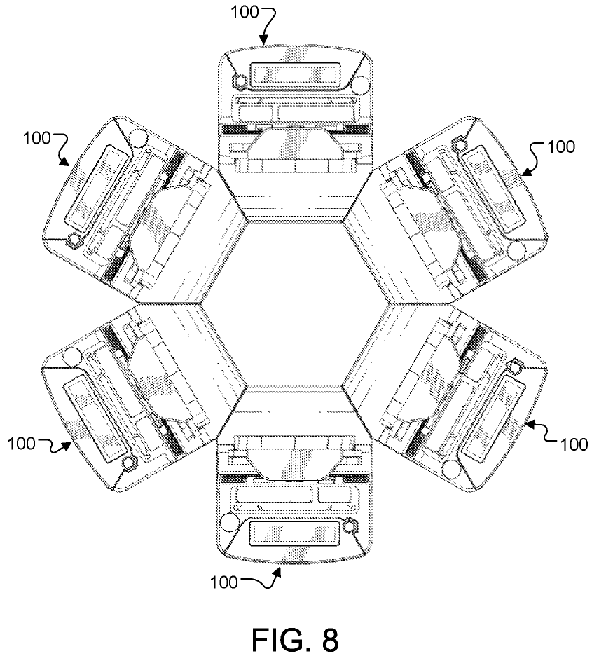

The construction of the tapering, angled back of the machine 100 allows for placement of the machines in configurations for better use of space than machines with rectangular cabinets having similarly sized displays and cabinet fronts. FIG. 8 is a top-down view of such an arrangement of gaming machines 100. As seen, six machines are arranged in a circular placement with their tapered portions adjacent or very nearly adjacent to each other, preferably as closely as possible with a little tolerance such as less than 1 cm. This arrangement is best achieved with the preferred 30 degree angle described above with respect to FIG. 6. However, this is not limiting and other suitable angles may be used such as 45 degrees (providing for optimal arrangement of 4 machines), 36 degrees (providing an optimal arrangement of 5 machines), or 25.7 degrees (providing an optimal arrangement of 7 machines).

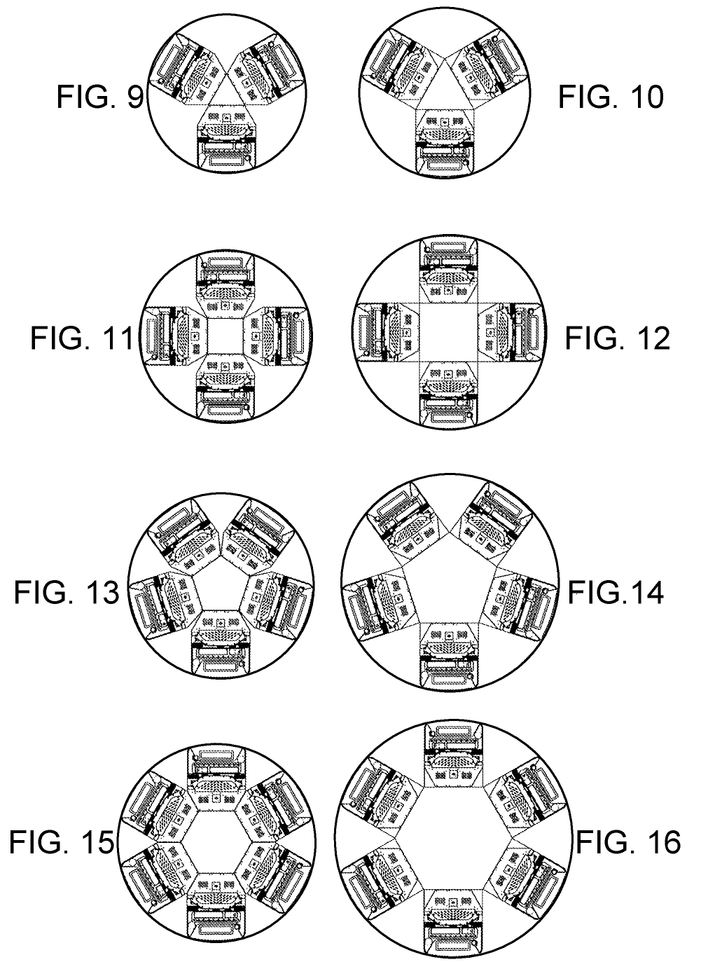

FIGS. 9-16 show a series of top-down diagrams showing group configurations of gaming machines 100 with the cabinet design described above compared to same-sized groups with spacing set at the equivalent of a rectangular machine with other dimensions all similar. This can be seen, for example, in FIG. 10 in which the three gaming cabinet outline has rectangular corners added to fill the area cleared by the tapering angles on the back side of the machines of FIG. 9. FIGS. 12, 14, and 16 show similar outlines for casino-floor groupings of gaming machines having four, five and six machine respectively, compared to the smaller groupings possible with the present design as depicted in FIGS. 11, 13, and 15. The six-machine group embodiment of FIG. 15 uses 20 percent less floor space than the comparable group of six rectangular cabinets of FIG. 16. As can be understood, the gaming machines are configured to be arranged in a circular arrangement with their cabinet backs facing inward to the circle and at least the back corners of their respective tapering wall sections are adjacent the respective neighboring corner of the respective neighboring tapering wall section. In such groups where the angle of the tapering wall section 207 is constructed to fit a designated size of group as described above (i.e., a 30 degree and for six machines), the respective neighboring tapering wall sections are placed flush with and preferably in contact with each other.

In other embodiments, similar gaming machine cabinets may be employed arranged in a circular group, each machine with wider screen displays mounted at the cabinet front side 102, with display edges extending past the edge of cabinets 101. In some such configurations, spacing of the display edges may determine the spacing of the group, providing a larger distances than the flush or nearly flush distances between the tapered sides of the cabinets employed in FIGS. 9, 11, 13, and 15, yet still benefiting from the increased clearance provided by the tapered design because a similarly sized rectangular machine would still not allow such spacing.

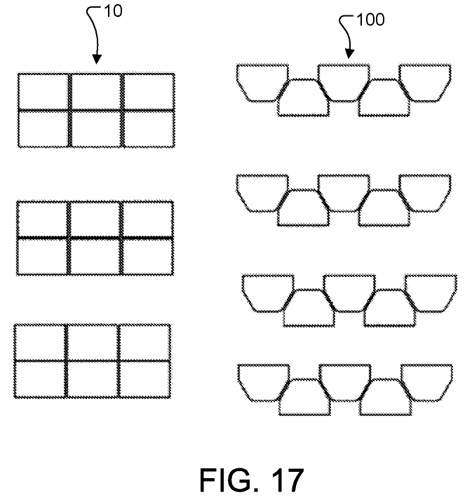

FIG. 17 is a diagram showing a comparison of row configurations for traditional rectangular gaming machine cabinets 10 versus rows of gaming machines 100 as described herein arranged with their tapered wall sections 207 placed flush to each other or near flush as discussed above. As can be seen on the right side of the diagrams, while fewer machines 100 are fit in a row, the depth of the back-to-back placement of machines is greatly reduced, allowing more rows to fit in the same floor area. As can be under stood, with the gaming machines arranged in first and second opposing rows placed back-to-back, as depicted with their respective tapering wall sections 207 are adjacent the respective tapering wall section of at least one machine in the opposing row, the tapering wall section constructed to allow a closer spacing of said rows than possible with a similar width rectangular machine. Further, the spacing between the fronts of machines 100 provides increase room between players stationed at adjacent machines.

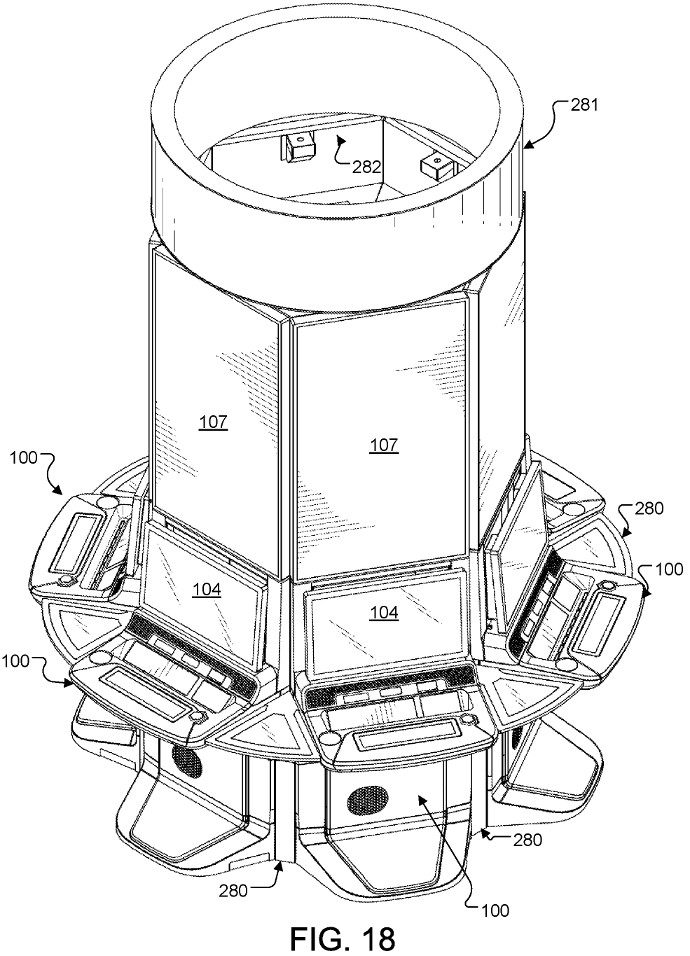

FIG. 18 is a perspective view of a group of gaming machines 100 including a topper display 281. In this version, the cabinets of gaming machines 100 are constructed as described herein, and the machines are arranged in a circular configuration of six machines, with their tapered wall sections 207 placed flush to each other. Each machine 100 includes a secondary display 107 above the primary display 204. Secondary displays 107 may be wider than primary displays 104 to extend laterally out to the point where adjacent displays 107 have edges touching or very close when the machines are placed in the flush grouped configuration as shown. For example, a preferred version of primary display 104 is a 28-inch wide display, and a preferred version of secondary display 107 is a 32 inch wide display. The gaps between adjacent machines toward the machines front sides are filled with spacer elements 280, which fill the space from the floor up to at least the bottom of displays 107, or all the way to the top of the cabinets. Spacer elements 280 include a wedge-shaped shelf that expands to fill the gap between adjacent ledges 106. Topper display 281 may be a passive sign or an electronic display with a curved display screen. A series of support braces 282 are mounted atop machines 100 both to support the upper portion of secondary displays 107 and to support and mount topper display 281. Preferably the topper display 281 is round or hexagonal and sized such that it extends to the front of secondary display 107 with no overhang or a slight overhand of a few cm at its widest point compared to the display. The depicted group of gaming machines may be employed, for example, to conduct group play, to promote a particular game title, bonus prize scheme, or progressive award common to the six machines. Topper display 281 may also display graphics related to bonus wins occurring on any of gaming machines 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A group of three or more gaming machines:
each gaming machine including:
a cabinet having a cabinet front, a cabinet back, a left cabinet side, a right cabinet side, a cabinet bottom, and a cabinet top, which together define an enclosure volume;
the left and right cabinet sides constructed with opposing tapering wall sections toward the cabinet back, the tapering wall sections connected to the cabinet back with the cabinet back having a smaller width than that of the cabinet front, presenting a narrower cabinet footprint along the cabinet back than the cabinet front, and providing a narrower cabinet dimension along the cabinet back than the cabinet front throughout the entire span from the cabinet bottom to the cabinet top;
a player control ledge projecting from the cabinet front including player controls presented along the player control ledge;
a credit voucher or currency receiver and voucher printer presented on the ledge or along the cabinet front; and
a primary video display device mounted at the cabinet front above the player control ledge;
the gaming machines configured to be arranged in a circular arrangement with their cabinet backs facing inward to the circle and at least the back corners of their respective tapering wall sections are adjacent the respective neighboring corner of the respective neighboring tapering wall section.

2. The group of gaming machines of claim 1, in which there are six gaming machines and the respective tapering wall sections of each machine are placed in contact with those of neighboring gaming machines.

3. The group of gaming machines of claim 2, further comprising a group of spacer elements adapted to be mounted between adjacent pairs of gaming machines of the group.

4. The group of gaming machines of claim 3, in which each gaming machine further comprises a secondary display mounted above the first display and wider than the first display, such that the secondary displays extend over respective spacer elements to be adjacent each other in the group configuration.

5. The group of gaming machines of claim 2, further including a round topper display configured to mount atop the group of gaming machines, spanning above each of the gaming machines when grouped as described, and present an outward facing display.

6. The group of gaming machines of claim 5, in which the topper display comprises a curved electronic display.

7. A gaming machine including:
a cabinet having a cabinet front, a cabinet back, a left cabinet side, a right cabinet side, a cabinet bottom, and a cabinet top, which together define an enclosure volume;
the left and right cabinet sides constructed opposing tapering wall sections toward the cabinet back, the tapering wall sections connected to the cabinet back with the cabinet back having a smaller width than that of the cabinet front, presenting a narrower cabinet footprint along the cabinet back than the cabinet front, and providing a narrower cabinet dimension along the cabinet back than the cabinet front throughout the entire span from the cabinet bottom to the cabinet top;
a player control ledge projecting from the cabinet front including player controls presented along the player control ledge;
a credit voucher or currency receiver and voucher printer presented on the ledge or along the cabinet front;
a primary video display device mounted at the cabinet front above the player control ledge; and
the gaming machine configured to be arranged in groups of similar machines with tapering wall sections adjacent to respective neighboring machines in the group, the tapering wall section constructed to allow a closer spacing of machines in said groups than possible with a similar width rectangular machine.

8. The gaming machine of claim 7, in which the tapering wall sections extend in the front to back direction at least 60% of the distance from the cabinet back to the front of primary video display at its lower edge.

9. The gaming machine of claim 7, in which the tapering wall sections extend in the front to back direction at least 70% of the distance from the cabinet back to the front of primary video display at its lower edge.

10. The gaming machine of claim 7, in which the tapering wall sections form an angle of 30 degrees from an angle perpendicular to the cabinet front.

11. A group of gaming machines:
each gaming machine including:
a cabinet having a cabinet front, a cabinet back, a left cabinet side, a right cabinet side, a cabinet bottom, and a cabinet top, which together define an enclosure volume;
the left and right cabinet sides constructed with opposing tapering wall sections toward the cabinet back, the tapering wall sections connected to the cabinet back with the cabinet back having a smaller width than that of the cabinet front, presenting a narrower cabinet footprint along the cabinet back than the cabinet front, and providing a narrower cabinet dimension along the cabinet back than the cabinet front throughout the entire span from the cabinet bottom to the cabinet top;
a player control ledge projecting from the cabinet front including player controls presented along the player control ledge;
a credit voucher or currency receiver and voucher printer presented on the ledge or along the cabinet front; and
a primary video display device mounted at the cabinet front above the player control ledge;
the gaming machines arranged in first and second opposing rows placed back-to-back, with their respective tapering wall sections are adjacent the respective tapering wall section of at least one machine in the opposing row, the tapering wall section constructed to allow a closer spacing of said rows than possible with a similar width rectangular machine.

12. The group of gaming machines of claim 11, in which the tapering wall sections of each respective machine form an angle of 30 degrees from an angle perpendicular to their respective cabinet front.

13. The group of gaming machines of claim 11, in which the tapering wall sections of each respective machine extend in the front to back direction at least 60% of the distance from the cabinet back to the front of primary video display at its lower edge.
